(19) United States
(12) Patent Application Publication
(10) Pub. No.: US 2015/0378806 A1
(43) Pub. Date: Dec. 31, 2015

(54) SYSTEM ANALYSIS DEVICE AND SYSTEM ANALYSIS METHOD

(71) Applicant: NEC CORPORATION, Minato-ku, Tokyo (JP)

(72) Inventor: Masanao Natsumeda, Tokyo (JP)

(21) Appl. No.: 14/766,880

(22) PCT Filed: Feb. 24, 2014
(86) PCT No.: PCT/JP2014/000949

§ 371 Date: Aug. 10, 2015

(30) Foreign Application Priority Data
Feb. 26, 2013 (JP) 2013-035784

(51) Int. Cl. G06F 11/07

(52) U.S. Cl. CPC G06F 11/079; G06F 11/0751; G06F 11/0772

(57) ABSTRACT

In variant relation analysis, an abnormality cause is accurately determined.

A system analysis device (100) includes a correlation model storage unit (112) and an abnormality cause extraction unit (104). The correlation model storage unit (112) stores a correlation model (122) indicating a correlation of a pair of metrics in a system. The abnormality cause extraction unit (104) extracts a metric of candidate for an abnormality cause on the basis of a detection sensitivity calculated for each metric associated with a correlation for which correlation destruction is detected in correlations included in the correlation model (122). The detection sensitivity indicates a likelihood of occurrence of correlation destruction in each correlation associated with the metric at the time of abnormality of the metric.

### TECHNICAL FIELD

The present invention relates to a system analysis device and a system analysis method.

### BACKGROUND ART

An example of an operation management system which models a system by using time-series information about system performance and determines a cause of failure, abnormality, or the like of the system by using the generated model is described in PTL 1.

The operation management system described in PTL1 generates a correlation model of the system by determining correlation functions expressing correlations between each pair in a plurality of metrics on the basis of measurements of the plurality of metrics of the system. Then, the operation management system detects destruction of correlations (correlation destruction) by using the generated correlation model to determine a failure cause of the system on the basis of the detected correlation destruction. This technology for analyzing a state of a system on the basis of correlation destruction is called invariant relation analysis.

As a related technology, a method for, when there is a change in a physical quantity of each of a plurality of points in a process from a reference point, determining a failure point on the basis of correlations between points, is disclosed in PTL 2.

### CITATION LIST

### Patent Literature

[PLT1] Japanese Patent Publication No. 4872944

[PLT2] Japanese Patent Application Laid-Open Publication No. S63-51936

### SUMMARY OF INVENTION

### Technical Problem

According to the invariant relation analysis of PTL1, metrics causing abnormality (abnormality cause metrics) are narrowed with reference to a state of correlation destruction occurring in a correlation model. When a large number of correlations associated with the abnormality cause metric are destructed, it is possible to narrow down to the metric as an abnormality cause. However, when only a small number of correlations associated with the abnormality cause metric are destructed, it may not be possible to narrow down to the metric as an abnormality cause.

FIG. 9 is a diagram illustrating an example of determination of an abnormality cause in the invariant relation analysis of PTL1. In FIG. 9, each of the nodes indicates a metric, while each of the arrows illustrated between the respective metrics indicates a correlation. The node illustrated in a thick line indicates a metric causing abnormality (abnormality cause metric), while a thick line arrow indicates a correlation for which correlation destruction is detected.

In FIG. 9, correlation destruction is detected in one correlation (between metrics A and C) as a result of abnormality of the metric A. In this case, it cannot be decided which metric corresponds to an abnormality cause in the metrics A and C associated with the correlation for which the correlation destruction is detected. For overcoming this problem, for example, a method for determining an abnormality cause metric, on the basis of a ratio of the number of correlations for which correlation destruction is detected to the total number of correlations (hereinafter referred to as correlation destruction ratio) for each metric, is used. According to this method, however, a ratio ½ indicating correlation destruction associated with the metric C is larger than a ratio ⅓ indicating correlation destruction associated with the metric A, wherefore the metric C is erroneously determined as the abnormality cause.

An object of the present invention is to solve the aforementioned problem, and to provide a system analysis device and a system analysis method, which are capable of accurately determining an abnormality cause in invariant relation analysis.

### Solution to Problem

A system analysis device according to an exemplary aspect of the invention includes: a correlation model storage means for storing a correlation model indicating a correlation of a pair of metrics in a system; and an abnormality cause extraction means for extracting a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.

A system analysis method according to an exemplary aspect of the invention includes: storing a correlation model indicating a correlation of a pair of metrics in a system; and extracting a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.

A computer readable storage medium according to an exemplary aspect of the invention records thereon a program, causing a computer to perform a method including: storing a correlation model indicating a correlation of a pair of metrics in a system; and extracting a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.

### Advantageous Effects of Invention

An advantageous effect of the present invention is that it is possible to accurately determine an abnormality cause in invariant relation analysis.

### BRIEF DESCRIPTION OF DRAWINGS

FIG. 1 is a block diagram illustrating a characteristic configuration according to a first exemplary embodiment of the present invention.

FIG. 2 is a block diagram illustrating a configuration of a system analysis device 100 according to the first exemplary embodiment of the present invention.

FIG. 3 is a flowchart illustrating an operation of the system analysis device 100 according to the first exemplary embodiment of the present invention.

FIG. 4 is a diagram illustrating an example of a correlation model 122 and detection sensitivities according to the first exemplary embodiment of the present invention.

FIG. 5 is a diagram illustrating an example of detection of correlation destruction and an example of comparison of detection sensitivities according to the first exemplary embodiment of the present invention.

FIG. 6 is a flowchart illustrating an operation of the system analysis device 100 according to a second exemplary embodiment of the present invention.

FIG. 7 is a diagram illustrating an example of the correlation model 122 and detection sensitivities according to the second exemplary embodiment of the present invention.

FIG. 8 is a diagram illustrating an example of detection of correlation destruction and an example of comparison of detection sensitivities according to the second exemplary embodiment of the present invention.

FIG. 9 is a diagram illustrating an example of determining an abnormality cause according to invariant relation analysis in PTL1.

### DESCRIPTION OF EMBODIMENTS

The following exemplary embodiment is described with an example of invariant relation analysis in an IT (Information Technology) system.

### First Exemplary Embodiment

A first exemplary embodiment of the present invention is hereinafter described.

First, a configuration according to the first exemplary embodiment of the present invention is described. FIG. 2 is a block diagram illustrating a configuration of a system analysis device 100 according to the first exemplary embodiment of the present invention.

Referring to FIG. 2, the system analysis device 100 according to the first exemplary embodiment of the present invention is connected with a monitored system including one or more monitored devices 200. Each of the monitored devices 200 is a device, such as a server device and a network device of various types, constituting an IT system.

The monitored device 200 obtains measurement data (measurements) about performance values of the monitored device 200 for a plurality of items at regular intervals, and transmits the obtained data to the system analysis device 100. The items of the performance values include, for example, use rates and use volumes of computer resources and network resources, such as a CPU (Central Processing Unit) use rate, a memory use rate, and a disk access frequency.

It is assumed herein that a set of the monitored device 200 and a performance value item is defined as a metric (performance index), and that a set of a plurality of metrics measured at an identical time is defined as performance information. Each metric is expressed in a numerical value such as an integer and a decimal. Each metric corresponds to an “element” for which a correlation model is generated in PTL1.

The system analysis device 100 generates a correlation model 122 of the monitored devices 200 on the basis of performance information collected from the monitored devices 200, and analyzes a state of the monitored devices 200 by using the generated correlation model 122.

The system analysis device 100 includes a performance information collection unit 101, a correlation model generation unit 102, a correlation destruction detection unit 103, an abnormality cause extraction unit 104, a performance information storage unit 111, a correlation model storage unit 112, a correlation destruction storage unit 113, and a detection sensitivity storage unit 114.

The performance information collection unit 101 collects performance information from the monitored devices 200.

The performance information storage unit 111 stores a time-series change of the performance information collected by the performance information collection unit 101 as performance series information.

The correlation model generation unit 102 generates the correlation model 122 of the monitored system on the basis of the performance series information.

The correlation model 122 includes correlation functions (or prediction expressions) expressing correlations of respective pairs of metrics. Each of the correlation functions is a function for predicting one of values of a pair of metrics based on time series of both of the pair, or time series of the other of the pair. Hereinafter, a metric in a pair of metrics predicted based on the correlation function is referred to as an objective metric, while the other metric in the pair of metrics is referred to as a non-objective metric.

The correlation model generation unit 102 determines a correlation function f(y, u) for a pair of metrics y(t) and u(t) by using Equation 1 (Math 1) in system identification processing executed for performance information in a predetermined modeling period, similarly to the operation management device in PTL1. In this case, the metrics y(t) and u(t) correspond to an objective metric and a non-objective metric, respectively. Values aₙ (n=1 through N) and bₘ (m=0 through M) are coefficients to be multiplied by y(t−n) and u(t−K−m), respectively. The values aₙ, bₘ, c, N, K, and M are determined such that a value of prediction accuracy (fitness) of a correlation function expressed in Equation 2 (Math 2) is maximum.

\hat{y}(t)≦f(y,u)=a₁y(t−1)+ . . . +a_{N}y(t−N)+b₀u(t−K)+ . . . +b_{M}u(t−K−M)+c [Math 1]

ŷ(t): PREDICTION VALUE OF OBJECTIVE METRIC

y(t): MEASUREMENT OF OBJECTIVE METRIC

u(t): MEASUREMENT OF NON-OBJECTIVE METRIC

$$F = [ 1 - \sqrt{\frac{{\sum }_{t = 1}^{N} {\vert y ( t ) - \hat{y} ( t ) \vert}^{2}}{{\sum }_{t = 1}^{N} {\vert y ( t ) - \overline{y} \vert}^{2}}} ] \\ \overline{y} \text{:} AVERAGE OF OBJECTIVE METRIC \qquad [ Math 2 ]$$

The correlation model generation unit 102 may use a set of correlation functions exhibiting prediction accuracy equal to or greater than a predetermined value, as the correlation model 122.

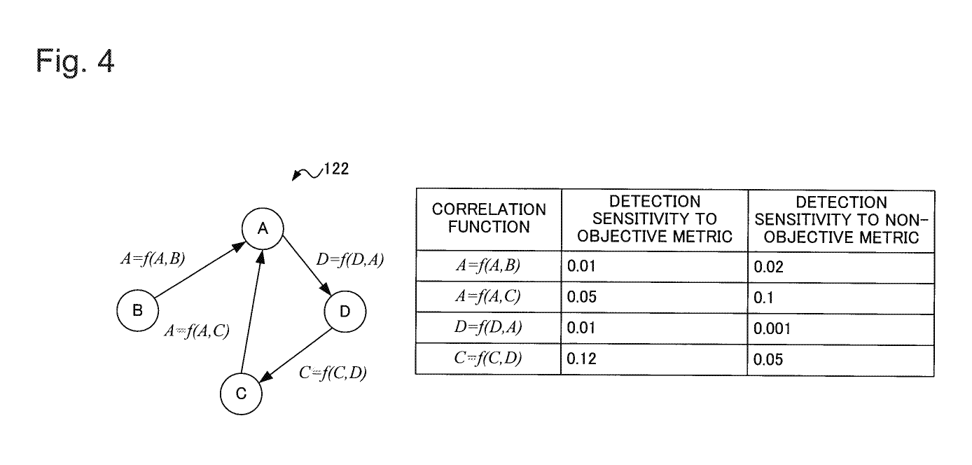

FIG. 4 is a diagram illustrating an example of the correlation model 122 and detection sensitivities according to the first exemplary embodiment of the present invention. In FIG. 4, the correlation model 122 is illustrated as a graph including nodes and arrows. Each of the nodes indicates a metric, while each of the arrows illustrated between the respective metrics indicates a correlation. A metric illustrated at a destination of each of the arrows corresponds to an objective metric.

In the correlation model 122 of FIG. 4, one metric is present for each of the monitored devices 200 to which device identifiers A through D are given (hereinafter referred to as metrics A through D). A correlation is defined for each of pairs in the metrics A through D. In addition, one correlation function for predicting one of a pair of metrics is defined for the correlation of each pair of metrics.

The correlation model storage unit 112 stores the correlation model 122 generated by the correlation model generation unit 102.

The correlation destruction detection unit 103 detects correlation destruction in a correlation contained in the correlation model 122 for newly input performance information.

The correlation destruction detection unit 103 detects correlation destruction for respective pairs of metrics similarly to the operation management device in PTL1. The correlation destruction detection unit 103 detects correlation destruction of a correlation for a pair when a difference (prediction error) between a measurement of an objective metric and a prediction value of the objective metric obtained by input of a measurement of a metric into the correlation function is equal to or greater than a predetermined threshold.

The correlation destruction storage unit 113 stores correlation destruction information indicating a correlation for which correlation destruction is detected.

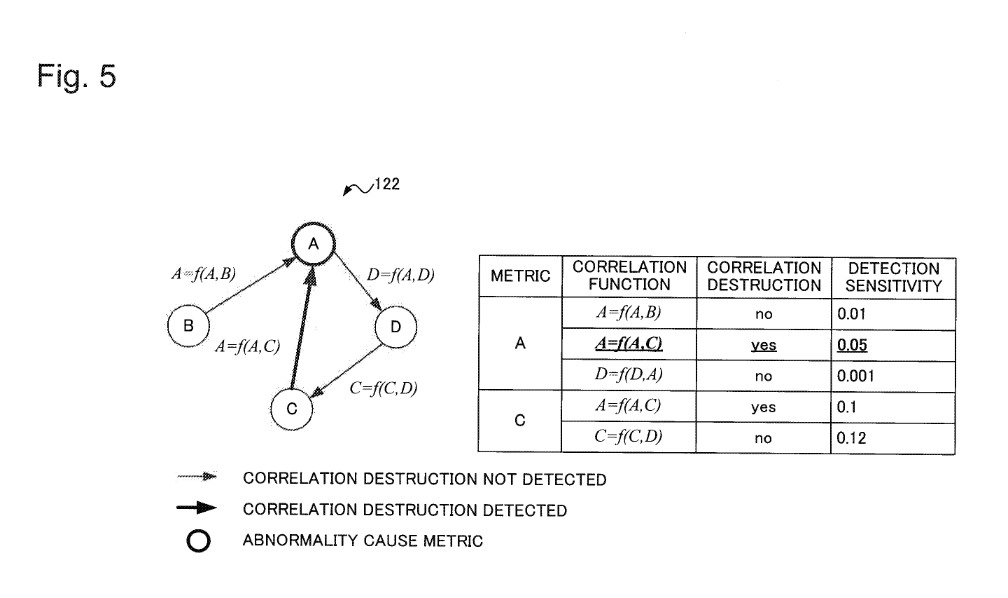

FIG. 5 is a diagram illustrating an example of detection of correlation destruction and an example of comparison of detection sensitivities according to the first exemplary embodiment of the present invention. In FIG. 5, a thick line arrow indicates a correlation for which correlation destruction is detected in the correlation model 122 in FIG. 4. In FIG. 5, a node illustrated in a thick line indicates a metric causing abnormality (abnormality cause metric). In the example of FIG. 5, correlation destruction occurs in the correlation between the metric A and the metric C due to abnormality of the monitored device 200 having the device identifier A.

The abnormality cause extraction unit 104 calculates a detection sensitivity of each of correlations included in the correlation model 122. The detection sensitivity indicates a degree of effect on a prediction value imposed by abnormality of a metric associated with a correlation, in other words, a likelihood of occurrence of correlation destruction in the correlation at the time of abnormality of the metric.

A method for calculating a detection sensitivity according to the first exemplary embodiment of the present invention is hereinafter described.

When a correlation is expressed by a correlation function in Equation 1 described above, a prediction error of a prediction value of an objective metric in the correlation function tends to increase in either the positive direction or the negative direction, at the time of a physical failure for either one of a pair of metrics. In this case, the likelihood (detection sensitivity) of correlation destruction in the correlation at the time of abnormality of the metric can be approximated by using the sum of the coefficients of the correlation function expressing the correlation.

In the first exemplary embodiment of the present invention, a detection sensitivity is defined as a value obtained by standardizing a sum of coefficients in a correlation function with a threshold for a prediction error applied for determining correlation destruction.

When the correlation function f(y, u) in Equation 1 is defined for the pair of metrics y and u, for example, the detection sensitivity is calculated as follows. A detection sensitivity S_{y} to the objective metric y is calculated by dividing the sum of coefficients to be multiplied by the objective metric y in the correlation function f(y, u) by a threshold for a prediction error, as expressed in Equation 3 (Math 3). Further, a detection sensitivity Sᵤ to the non-objective metric u is calculated by dividing the sum of coefficients to be multiplied by the non-objective metric u in the correlation function f(y, u) by the threshold for the prediction error, as expressed in Equation 4 (Math 4).

$$\begin{matrix}{S}_{y} = \frac{\vert 1 + {\sum }_{i = 1}^{N} {a}_{i} \vert}{Threshold} & [ Math 3 ] \\ {S}_{u} = \frac{\vert {\sum }_{i = 0}^{M} {b}_{i} \vert}{Threshold} & [ Math 4 ]\end{matrix}$$

Here “Threshold” is a threshold for a prediction error applied for determining correlation destruction by using the correlation function f(y, u). A value of “Threshold” is determined by the correlation model generation unit 102 on the basis of the maximum value or a standard deviation of a prediction error for performance information during a modelling period, for example. The value of “Threshold” may be determined by an administrator or the like for each correlation function.

The abnormality cause extraction unit 104 further extracts a metric of candidate for abnormality cause, by using detection sensitivities calculated for each of the metrics associated with a correlation for which correlation destruction is detected. Here, the abnormality cause extraction unit 104 uses the detection sensitivities of respective correlations associated with each of the metrics.

The detection sensitivity storage unit 114 stores detection sensitivities calculated by the abnormality cause extraction unit 104.

The system analysis device 100 may be configured by a computer which includes a CPU and a storage medium storing a program, and operates under control of the program. The performance information storage unit 111, the correlation model storage unit 112, the correlation destruction storage unit 113, and the detection sensitivity storage unit 114 may be either separate storage media for each, or configured by a one-piece storage medium.

Next, an operation of the system analysis device 100 according to the first exemplary embodiment of the present invention is described.

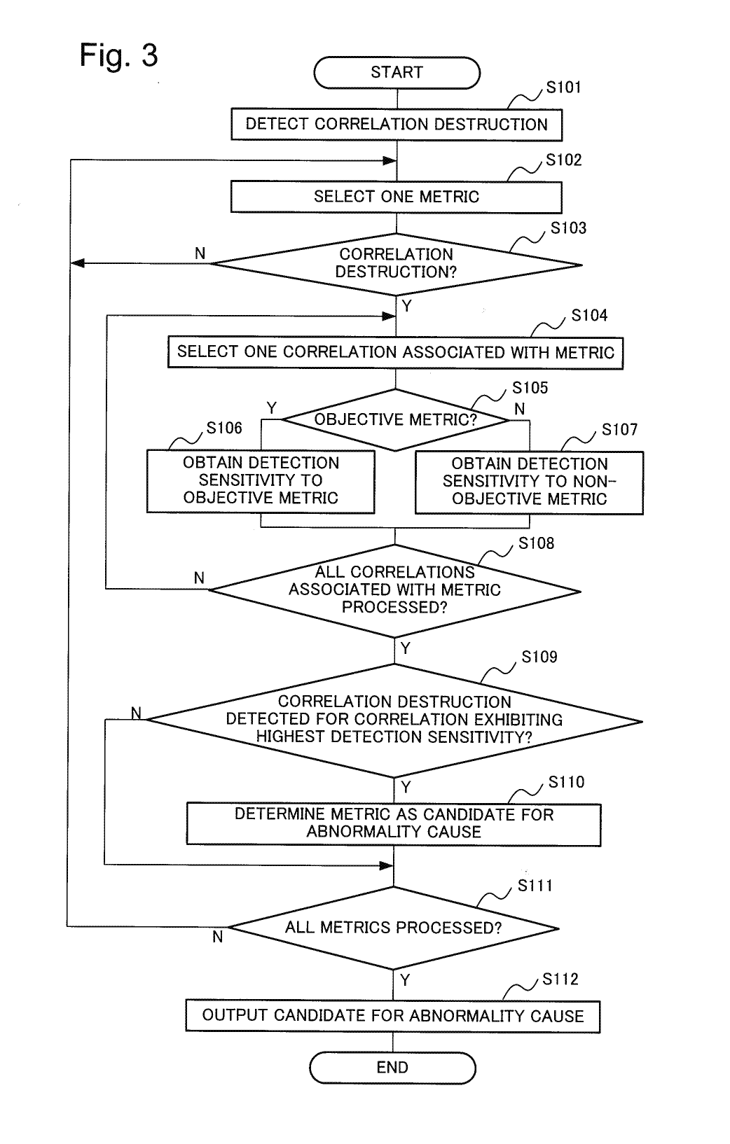

FIG. 3 is a flowchart illustrating an operation of the system analysis device 100 according to the first exemplary embodiment of the present invention.

It is assumed herein that the correlation model 122 illustrated in FIG. 4 is generated by the correlation model generation unit 102, and stored in the correlation model storage unit 112. It is further assumed that detection sensitivities illustrated in FIG. 4 is calculated by the abnormality cause extraction unit 104, and stored in the detection sensitivity storage unit 114.

First, the correlation destruction detection unit 103 detects correlation destruction in a correlation included in the correlation model 122, by using performance information newly collected by the performance information collection unit 101 (step S101).

For example, the correlation destruction detection unit 103 detects correlation destruction illustrated in FIG. 5 for performance information newly collected.

The abnormality cause extraction unit 104 selects one of metrics included in the correlation model 122 (step S102).

When correlations associated with the selected metric include a correlation for which correlation destruction is detected (step S103/Y), the abnormality cause extraction unit 104 selects one of correlations associated with the selected metric (step S104). When the selected metric corresponds to the objective metric of the correlation function of the selected correlation (step S105/Y), the abnormality cause extraction unit 104 obtains a detection sensitivity to the objective metric of the correlation function from the detection sensitivity storage unit 114.

When the selected metric is not the objective metric of the correlation function of the selected correlation (step S105/N), the abnormality cause extraction unit 104 obtains a detection sensitivity to the non-objective metric of the correlation from the detection sensitivity storage unit 114. The abnormality cause extraction unit 104 repeats the processing from step S104 to step S107 for all the correlations associated with the selected metric (step S108).

When the metric A is selected, for example, the abnormality cause extraction unit 104 obtains a detection sensitivity (=0.01) to the objective metric of a correlation function f(A, B) as illustrated in FIG. 5, in consideration that the metric A is the objective metric of the correlation function f(A, B). Similarly, the abnormality cause extraction unit 104 obtains a detection sensitivity (=0.05) to the objective metric of a correlation function f(A, C), in consideration that the metric A is the objective metric of the correlation function f(A, C). Further, the abnormality cause extraction unit 104 obtains a detection sensitivity (=0.001) to the non-objective metric of a correlation function f(D, A), in consideration that the metric A is the non-objective metric of the correlation function f(D, A).

Next, the abnormality cause extraction unit 104 compares detection sensitivities obtained for the respective correlation functions associated with the selected metric, and determines whether or not correlation destruction is detected for the correlation function exhibiting the highest detection sensitivity (step S109). When correlation destruction is detected for the correlation function exhibiting the highest detection sensitivity in step S109 (step S109/Y), the abnormality cause extraction unit 104 determines the selected metric as a candidate for the abnormality cause.

In the case of the foregoing, for example, the detection sensitivity (=0.05) of the correlation between metrics A and C for which correlation destruction is detected is higher than the detection sensitivity (=0.01) of the correlation between the metrics A and B and the detection sensitivity (=0.001) of the correlation between the metrics A and D for both of which correlation destruction is not detected. In other words, correlation destruction is detected for the correlation exhibiting the highest detection sensitivity. Accordingly, the abnormality cause extraction unit 104 determines the metric A as the candidate for the abnormality cause.

The abnormality cause extraction unit 104 repeats the processing from step S102 to step S110 for all the metrics included in the correlation model 122 (step S111).

When the metric C is selected, for example, the abnormality cause extraction unit 104 obtains a detection sensitivity (=0.1) to the non-objective metric of the correlation function f(A, C) as illustrated in FIG. 5, in consideration that the metric C is the non-objective metric of the correlation function f(A, C). Further, the abnormality cause extraction unit 104 obtains a detection sensitivity (=0.12) to the objective metric of a correlation function f(C, D), in consideration that the metric C is the objective metric of the correlation function f(C, D).

In this case, the detection sensitivity (=0.1) of the correlation between the metrics A and C for which correlation detection is detected is lower than the detection sensitivity (=0.12) of the correlation between the metrics C and D for which correlation destruction is not detected. In other words, correlation destruction is not detected for the correlation exhibiting the highest detection sensitivity. Accordingly, the abnormality cause extraction unit 104 does not determine the metric C as a candidate for the abnormality cause.

Finally, the abnormality cause extraction unit 104 outputs the identifier of the metric determined as the candidate for the abnormality cause to an administrator or the like via an output unit (not illustrated) (step S112).

For example, the abnormality cause extraction unit 104 outputs the metric A as the candidate for the abnormality cause.

The operation according to the first exemplary embodiment of the present invention is completed by the processing above described.

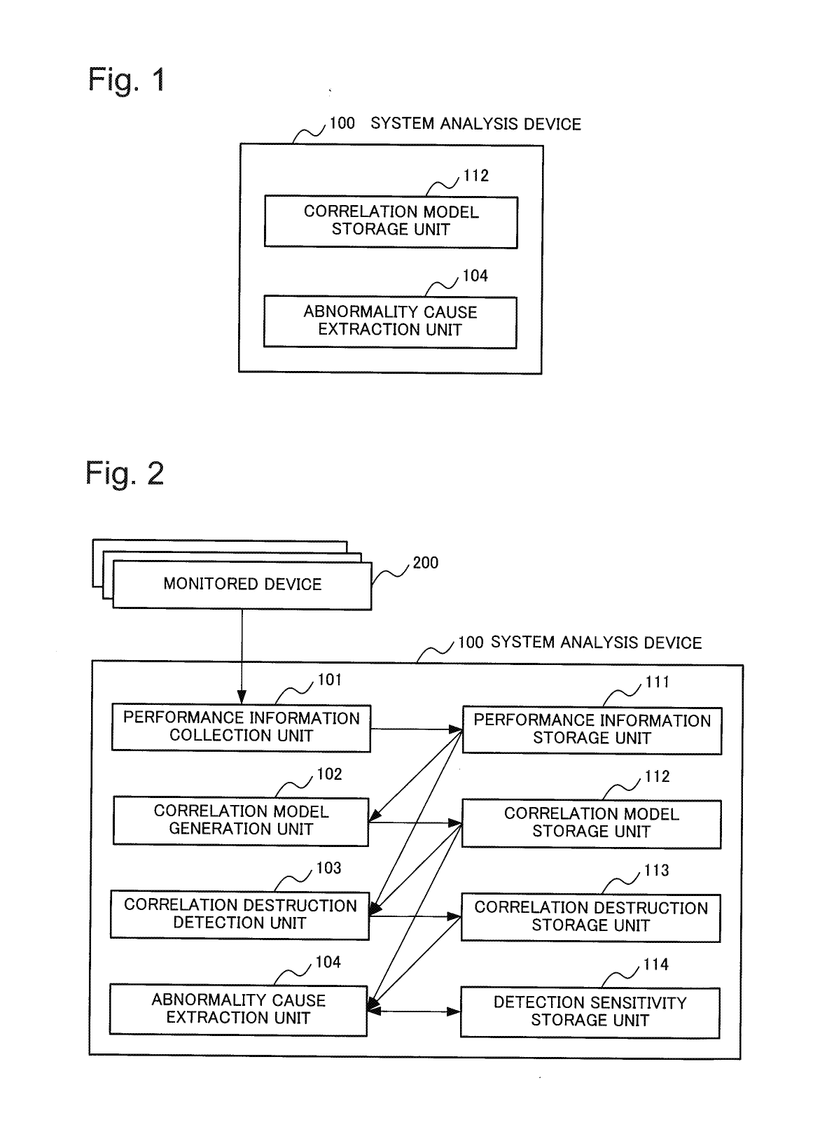

Next, a characteristic configuration of the first exemplary embodiment of the present invention will be described. FIG. 1 is a block diagram illustrating the characteristic configuration according to the first exemplary embodiment of the present invention.

Referring to FIG. 1, a system analysis device 100 includes the correlation model storage unit 112 and the abnormality cause extraction unit 104.

The correlation model storage unit 112 stores a correlation model 122 indicating a correlation of a pair of metrics in a system.

The abnormality cause extraction unit 104 extracts a metric of candidate for an abnormality cause on the basis of a detection sensitivity calculated for each metric associated with a correlation for which correlation destruction is detected in correlations included in the correlation model 122. The detection sensitivity indicates a likelihood of occurrence of correlation destruction in each correlation associated with the metric at the time of abnormality of the metric.

According to the first exemplary embodiment of the present invention, an abnormality cause is accurately determined in invariant relation analysis. This is because the abnormality cause extraction unit 104, instead of extracting all metrics associated with a correlation for which correlation destruction is detected as candidates for the abnormality cause, narrows metrics of candidate for the abnormality cause. In other words, the abnormality cause extraction unit 104 narrows metrics of candidate for the abnormality cause on the basis of detection sensitivities calculated for respective metrics associated with the correlation for which the correlation destruction is detected. The detection sensitivity indicates a likelihood of occurrence of correlation destruction in a correlation associated with the metric at the time of abnormality of the metric.

### Second Exemplary Embodiment

Next, a second exemplary embodiment according to the present invention is described.

The second exemplary embodiment according to the present invention is different from the first exemplary embodiment of the present invention in that a candidate for an abnormality cause is extracted by using a higher detection sensitivity in detection sensitivities of two correlation functions, when the two correlation functions are defined for a correlation of each pair of metrics.

The configuration of the system analysis device 100 according to the second exemplary embodiment of the present invention is similar to the configuration thereof according to the first exemplary embodiment of the present invention (FIG. 2).

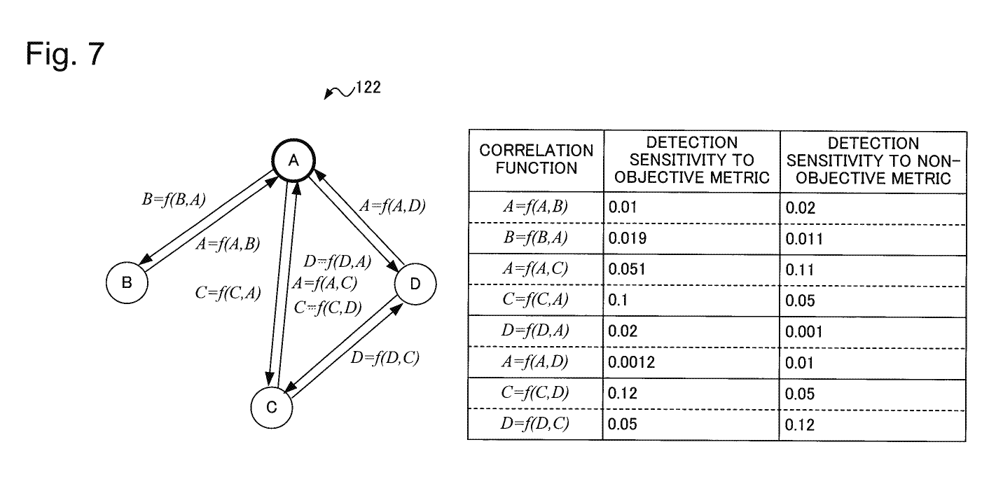

FIG. 7 is a diagram illustrating an example of the correlation model 122 and detection sensitivities according to the second exemplary embodiment of the present invention. In case of the correlation model 122 in FIG. 7, two correlation functions are defined for each pair of metrics for predicting the metrics of the pair.

The abnormality cause extraction unit 104 extracts a metric of candidate for an abnormality cause by using a higher detection sensitivity in detection sensitivities of two correlation functions expressing each correlation.

Next, an operation of the system analysis device 100 according to the second exemplary embodiment according to the present invention is described.

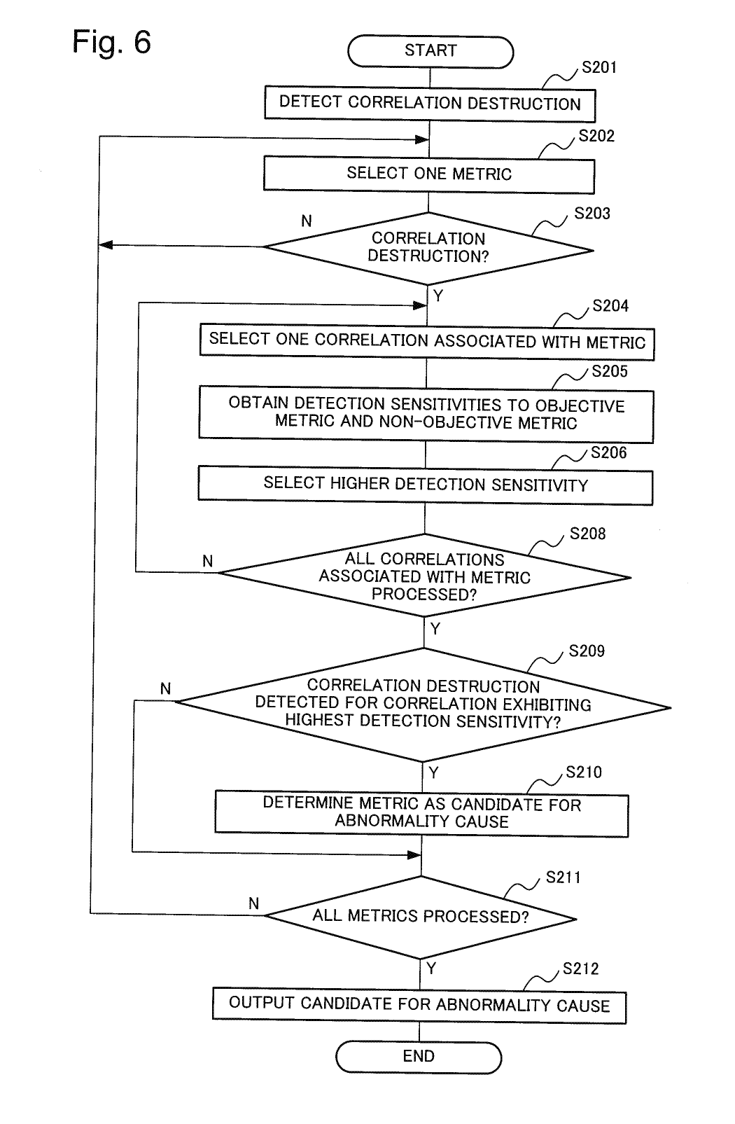

FIG. 6 is a flowchart illustrating an operation of the system analysis device 100 according to the second exemplary embodiment of the present invention.

The operation according to the second exemplary embodiment of the present invention is similar to the operation according to the first exemplary embodiment except for obtaining processing of a detection sensitivity (steps S205 and S206 in FIG. 6) executed by the abnormality cause extraction unit 104.

It is assumed herein that the correlation model 122 illustrated in FIG. 7 is generated by the correlation model generation unit 102, and stored in the correlation model storage unit 112. It is also assumed that detection sensitivities illustrated in FIG. 7 is calculated by the abnormality cause extraction unit 104, and stored in the detection sensitivity storage unit 114.

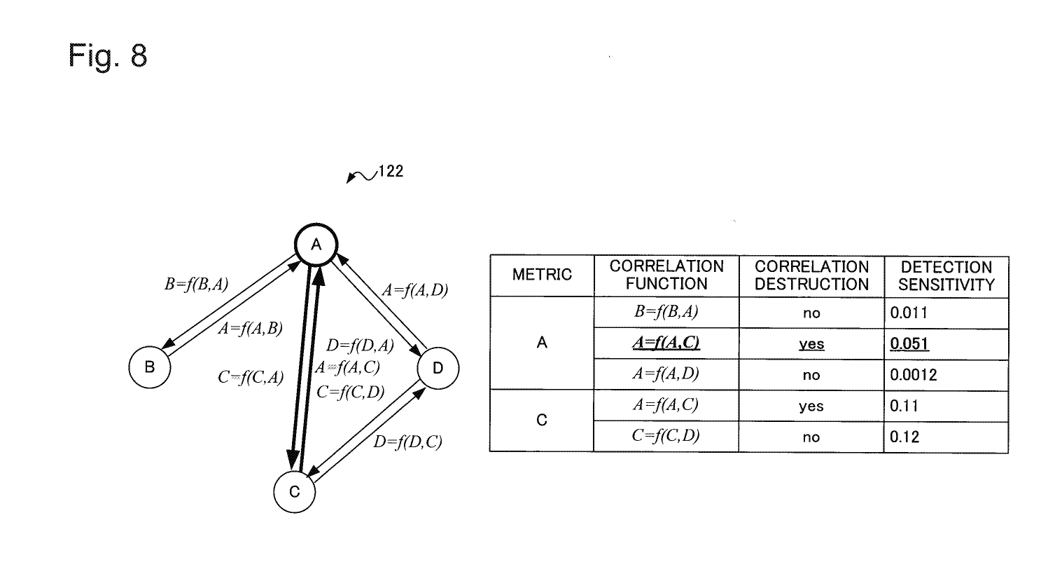

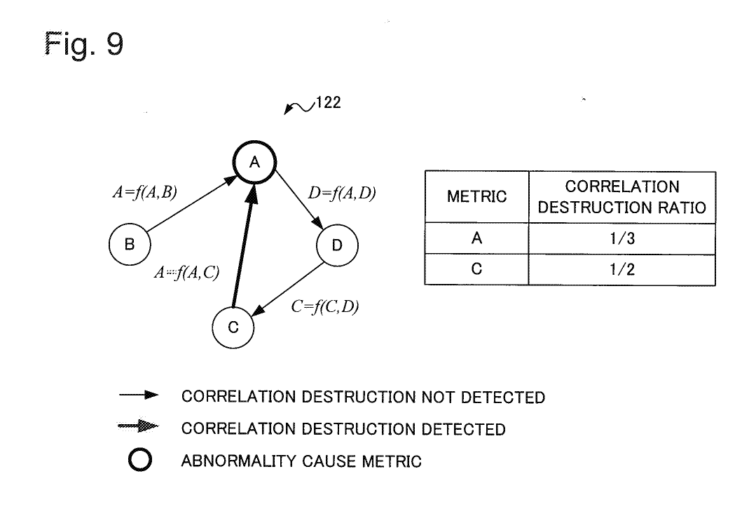

FIG. 8 is a diagram illustrating an example of detection of correlation destruction and an example of comparison of detection sensitivities. In this case, correlation destruction is detected for each of two correlation functions with respect to a correlation of each pair of metrics.

For example the correlation destruction detection unit 103 detects correlation destruction illustrated in FIG. 8 for performance information newly collected.

The abnormality cause extraction unit 104 obtains a detection sensitivity to an objective metric of a correlation function which sets the selected metric as the objective metric in two correlation functions of the selected correlation. Further, the abnormality cause extraction unit 104 obtains a detection sensitivity to a non-objective metric of a correlation function which sets the selected metric as the non-objective metric (step S205). Then, the abnormality cause extraction unit 104 selects a set of the higher detection sensitivity in the detection sensitivities thus obtained, and a detection state of correlation destruction (step S206).

When the metric A is selected, for example, the abnormality cause extraction unit 104 obtains a detection sensitivity (=0.01) to the objective metric of the correlation function f(A, B), and a detection sensitivity (=0.011) to the non-objective metric of the correlation function f(B, A). Then, the abnormality cause extraction unit 104 selects the higher detection sensitivity (=0.011) and a detection state of correlation destruction (not detected), as illustrated in FIG. 8. Further, the abnormality cause extraction unit 104 selects a detection sensitivity (=0.051) to the objective metric of the correlation function f(A, C) and a detection state of correlation destruction (detected), and a detection sensitivity (=0.0012) to the objective metric of the correlation function f(A, D) and a detection state of correlation destruction (not detected).

In this case, the detection sensitivity (=0.051) of the correlation between the metrics A and C for which correlation destruction is detected is higher than the detection sensitivity (=0.01) of the correlation between the metrics A and B and the detection sensitivity (=0.0012) of the correlation between the metrics A and D for both of which correlation destruction is not detected. In other words, correlation destruction is detected for the correlation exhibiting the highest detection sensitivity. Accordingly, the abnormality cause extraction unit 104 determines the metric A as a candidate for the abnormality cause.

When the metric C is selected, the abnormality cause extraction unit 104 selects a detection sensitivity (=0.11) to the non-objective metric of the correlation function f(A, C) and a detection state of correlation destruction (detected), as illustrated in FIG. 8. Further, the abnormality cause extraction unit 104 selects a detection sensitivity (=0.12) to the objective metric of the correlation function f(C, D) and a detection state of correlation destruction (not detected).

In this case, the detection sensitivity (=0.11) of the correlation between the metrics A and C for which correlation destruction is detected is lower than the detection sensitivity (=0.12) of the correlation between the metrics C and D for which correlation destruction is not detected. In other words, correlation destruction is not detected for the correlation exhibiting the highest detection sensitivity. Accordingly, the abnormality cause extraction unit 104 does not determine the metric C as a candidate for the abnormality cause.

Then, the abnormality cause extraction unit 104 outputs the metric A as a candidate for the abnormality cause.

The operation according to the second exemplary embodiment of the present invention is completed by the processing above described.

According to the second exemplary embodiment of the present invention, an abnormality cause is more accurately determined than in the first exemplary embodiment of the present invention. This is because the abnormality cause extraction unit 104 extracts a metric of candidate for an abnormality cause by using a higher detection sensitivity in detection sensitivities of two correlation functions expressing each correlation.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, while a detection sensitivity of a correlation function is calculated by using Equation 3 and Equation 4 in the exemplary embodiments of the present invention, a detection sensitivity may be determined by other methods as long as a larger value is obtainable in accordance with a coefficient to be multiplied by a metric. For example, the abnormality cause extraction unit 104 may determine a detection sensitivity by using a conversion table of detection sensitivities in correspondence with coefficients. Alternatively, detection sensitivity may be determined by a method other than methods using coefficients as long as a likelihood of occurrence of correlation destruction at the time of abnormality of a metric is indicated.

While a metric is determined as a candidate for an abnormality cause when correlation destruction is detected for a correlation exhibiting the highest detection sensitivity, according to the exemplary embodiments of the present invention, a candidate for an abnormality cause may be determined by other methods as long as the candidate for the abnormality cause is extractable on the basis of a detection sensitivity. For example, the abnormality cause extraction unit 104 may determine a candidate for an abnormality cause, on the basis of scores which increase in accordance with a detection number of correlation destruction for a correlation function exhibiting a high detection sensitivity.

According to the exemplary embodiments of the present invention, as a monitored system, an IT system including a server device, a network device, or the like as the monitored device 200 is used. However, the monitored system may be other types of systems as long as a correlation model of the monitored system can be generated to determine an abnormality cause based on correlation destruction. For example, the monitored system may be a plant system, a structure, transportation equipment, or the like. In this case, the system analysis device 100, for example, generates the correlation model 122 for metrics corresponding to values of various types of sensors, and performs correlation destruction detection and extraction of a candidate for abnormality cause.

This application is based upon and claims the benefit of priority from Japanese Patent Application No. 2013-035784, filed on Feb. 26, 2013, the disclosure of which is incorporated herein in its entirety by reference.

### INDUSTRIAL APPLICABILITY

The present invention is applicable to invariant relation analysis for determining a cause of system abnormality or failure based on correlation destruction detected on a correlation model.

### REFERENCE SIGNS LIST

100 system analysis device
101 performance information collection unit
102 correlation model generation unit
103 correlation destruction detection unit
104 abnormality cause extraction unit
111 performance information storage unit
112 correlation model storage unit
113 correlation destruction storage unit
114 detection sensitivity storage unit
122 correlation model
200 monitored device

What is claimed is:

1. A system analysis device comprising:
a correlation model storage unit which stores a correlation model indicating a correlation of a pair of metrics in a system; and
an abnormality cause extraction unit which extracts a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.

2. The system analysis device according to claim 1, wherein,
for each metric associated with the correlation for which the correlation destruction is detected, when the correlation destruction is detected in a correlation exhibiting the highest detection sensitivity in correlations associated with the metric, the abnormality cause extraction unit determines the metric as the candidate for the abnormality cause.

3. The system analysis device according to claim 1, wherein
a correlation of a pair of the metrics is expressed by a correlation function that predicts a value of one of the metrics of the pair based on time series of both the metrics of the pair, or time series of the other metric of the pair, and
the detection sensitivity of the correlation to the metric associated with the correlation is determined so as to increase in accordance with a coefficient to be multiplied by the metric in the correlation function of the correlation.

4. The system analysis device according to claim 3, wherein
the detection sensitivity of the correlation to the metric associated with the correlation is further determined so as to decrease in accordance with a threshold for a prediction error applied for determining correlation destruction by using the correlation function of the correlation.

5. The system analysis device according to claim 3, wherein
a correlation of a pair of the metrics is expressed by two correlation functions predicting the one and the other of the pair, respectively, and
the abnormality cause extraction unit extracts the metric of candidate for the abnormality cause by using the higher detection sensitivity in detection sensitivities of two correlation functions expressing a correlation of each metric associated with the correlation for which the correlation destruction is detected.

6. A system analysis method comprising:
storing a correlation model indicating a correlation of a pair of metrics in a system; and
extracting a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.

7. The system analysis method according to claim 6, wherein,
when extracting a metric of candidate for an abnormality cause, for each metric associated with the correlation for which the correlation destruction is detected, when the correlation destruction is detected in a correlation exhibiting the highest detection sensitivity in correlations associated with the metric, determining the metric as the candidate for the abnormality cause.

8. The system analysis method according to claim 6, wherein
a correlation of a pair of the metrics is expressed by a correlation function that predicts a value of one of the metrics of the pair based on time series of both the metrics of the pair, or time series of the other metric of the pair, and
the detection sensitivity of the correlation to the metric associated with the correlation is determined so as to increase in accordance with a coefficient to be multiplied by the metric in the correlation function of the correlation.

9. The system analysis method according to claim 8, wherein
the detection sensitivity of the correlation to the metric associated with the correlation is further determined so as to decrease in accordance with a threshold for a prediction error applied for determining correlation destruction by using the correlation function of the correlation.

10. The system analysis method according to claim 8, wherein
a correlation of a pair of the metrics is expressed by two correlation functions predicting the one and the other of the pair, respectively, and
when extracting a metric of candidate for an abnormality cause, extracting the metric of candidate for the abnormality cause by using the higher detection sensitivity in detection sensitivities of two correlation functions expressing a correlation of each metric associated with the correlation for which the correlation destruction is detected.

11. A non-transitory computer readable storage medium recording thereon a program, causing a computer to perform a method comprising:
storing a correlation model indicating a correlation of a pair of metrics in a system; and
extracting a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.

12. The non-transitory computer readable storage medium recording thereon the program according to claim 11, wherein,
when extracting a metric of candidate for an abnormality cause, for each metric associated with the correlation for which the correlation destruction is detected, when the correlation destruction is detected in a correlation exhibiting the highest detection sensitivity in correlations associated with the metric, determining the metric as the candidate for the abnormality cause.

13. The non-transitory computer readable storage medium recording thereon the program according to claim 11, wherein
a correlation of a pair of the metrics is expressed by a correlation function that predicts a value of one of the metrics of the pair based on time series of both the metrics of the pair, or time series of the other metric of the pair, and
the detection sensitivity of the correlation to the metric associated with the correlation is determined so as to increase in accordance with a coefficient to be multiplied by the metric in the correlation function of the correlation.

14. The non-transitory computer readable storage medium recording thereon the program according to claim 13, wherein
the detection sensitivity of the correlation to the metric associated with the correlation is further determined so as to decrease in accordance with a threshold for a prediction error applied for determining correlation destruction by using the correlation function of the correlation.

15. The non-transitory computer readable storage medium recording thereon the program according to claim 13, wherein
a correlation of a pair of the metrics is expressed by two correlation functions predicting the one and the other of the pair, respectively, and
when extracting a metric of candidate for an abnormality cause, extracting the metric of candidate for the abnormality cause by using the higher detection sensitivity in detection sensitivities of two correlation functions expressing a correlation of each metric associated with the correlation for which the correlation destruction is detected.

16. A system analysis device comprising:
a correlation model storage means for storing a correlation model indicating a correlation of a pair of metrics in a system; and
an abnormality cause extraction means for extracting a metric of candidate for an abnormality cause on the basis of a detection sensitivity calculated for each metric associated with a correlation for which correlation destruction is detected in correlations included in the correlation model, the detection sensitivity indicating a likelihood of occurrence of correlation destruction in each correlation associated with the metric at the time of abnormality of the metric.
